(19) United States
(12) Patent Application Publication
(10) Pub. No.: US 2003/0032679 A1
(43) Pub. Date: Feb. 13, 2003

(54) Non-aqueous dispersion of nanocrystalline metal oxides

(76) Inventors: Roger H. Cayton, Naperville, IL (US); Marc L. Kullberg, Lisle, IL (US)

Correspondence Address: WILDMAN, HARROLD, ALLEN & DIXON, 225 WEST WACKER DRIVE, CHICAGO, IL, 60606, US

(21) Appl. No.: 10/174,955

(22) Filed: Jun. 20, 2002

Related U.S. Application Data
(60) Provisional application No. 60/299,781, filed on Jun. 20, 2001.

(51) Int. Cl. C09K 3/00

(52) U.S. Cl. 516/33

(57) ABSTRACT

A process to prepare a stable dispersion of nanoparticles and non-aqueous media. A polymeric dispersant is combined with non-aqueous media to form a mixture. Nanoparticles are then added to the mixture.

### FIELD

The present invention relates to the preparation of stable dispersions of substantially spherical nanocrystalline metal oxides in non-aqueous media. Stable dispersions of substantially spherical nanocrystalline metal oxides in non-aqueous media would be of use as a component of transparent coatings on surfaces to yield unique properties such as abrasion resistance, radiation absorption, and catalytic function. Stable non-aqueous dispersions may also function as abrasive or polishing fluids, thermal fluids, catalytic additives, electro-rheological fluids, etc. Such dispersions could also act as a convenient means of transporting well-dispersed nanocrystalline metal oxides to a point of application.

### BACKGROUND

Conventionally, stable colloidal dispersions of metal oxides in non-aqueous media are prepared using long-chain carboxylic acids (fatty acids) or diesters of phosphoric acid in non-aqueous solvents (See, U.S. Pat. No. 6,093,223 (Lemaire, et al.), U.S. Pat. No. 6,136,048 (Rhodia Chimie) and U.S. Pat. No. 6,210,451 (Rhone-Poulenc Chimie)). Such dispersions comprise agglomerates of crystallites, which are nanometer sized, and exhibit rapid settling of the metal oxide particles. Another method used to stabilize metal oxides in non-aqueous media has been to prepare hydrocarbon-soluble coordination compounds such as ceric 2,4-hexandionate or other acetylacetonate derivatives (See, U.S. Pat. Nos. 4,036,605 and 4,211,535 (Hartle), U.S. Pat. No. 5,716,547 (Rhone Poulenc Chimie)). Such coordination compounds may in certain instances yield stable dispersions, but also substantially alter the nature of the nanocrystalline oxide.

Based on conventional methodology for the dispersion of metal oxide particles in non-aqueous media an attempt was made to disperse substantially spherical nanocrystalline metal oxides using surfactants well known in the art. However, when conventional surfactants were employed in a manner and at concentrations expected to result in stable dispersions of substantially spherical nanocrystalline metal oxide particles none of the materials or methodologies described in the prior art yielded stable dispersions. Instead, attempts to prepare substantially stable dispersions of substantially spherical nanocrystalline metal oxides in non-aqueous media using conventional surfactants lead to either rapid settling of the metal oxide particles, or agglomeration followed by rapid settling.

Surprisingly, polymeric dispersants, comprised of polymeric chains (molecules with repeating backbone units) and featuring one or more anchor groups, were found to be very effective at yielding substantially stable dispersions of substantially spherical nanocrystalline metal oxides in non-aqueous media. Dispersion stability is enhanced if the polymeric dispersant is essentially soluble in the non-aqueous media.

### SUMMARY

Polymeric dispersants with one or more anchor groups and polymeric chains were very effective at yielding substantially stable dispersions of substantially spherical nanocrystalline metal oxides in non-aqueous media. Dispersion stability was enhanced if the polymeric dispersant was soluble in the non-aqueous media.

In one example the invention comprises a process to prepare a stable dispersion of nanoparticles and non-aqueous media. The process includes combining a polymeric dispersant with the non-aqueous media to form a mixture and adding nanoparticles to the mixture.

### DETAILED DESCRIPTION

A detailed discussion of exemplary embodiments of the invention is presented herein, for illustrative purposes.

The dispersability of substantially spherical metal oxides was evaluated in non-aqueous media using a variety of pigment dispersants, surfactants, wetting agents, coupling agents, etc. (referred to collectively as dispersants). The non-aqueous media is selected from a group comprising polar hydrocarbons, non-polar hydrocarbons, alcohols, and silicones. The evaluated dispersants had the following characteristics:

Molecular size varied from high molecular weight polymers to low molecular weight coupling agents;

Anchoring groups were selected from a group comprising acidic, basic, and neutral; and

Ionic character was selected from a group comprising cationic, anionic, and neutral.

The one criterion required for each of the dispersants was that it be soluble in the non-aqueous media.

The dispersion of substantially spherical nanocrystalline metal oxide or mixed metal oxide (referred to collectively as “oxides”) in non-aqueous media was evaluated by the following criterion:

Dispersion appearance and viscosity—The lower the dispersion viscosity at a given nanocrystalline metal oxide concentration, the more effective the dispersant.

Solvated Particle Size—The smaller the mean particle size measured for solvated nanocrystalline metal oxides in dispersion, the more effective the dispersant. SPS was measured by dynamic light scattering (DLS) of the dispersed particles and reported as the mean volume-weighted diameter of the solvated particle. The solvated particle diameter is approximately 3 to 5 times more than the discrete particle diameter for a substantially spherical nanocrystalline metal oxide, depending on the metal oxide—non-aqueous media pair.

Dispersion Stability—The greater the stability of a dispersion of nanocrystalline metal oxide the more effective the dispersant.

The study evaluated substantially spherical nanocrystalline metal oxide concentrations in the non-aqueous media from 0.001-wt % to 60-wt % and dispersant concentration with respect to metal oxide from 0.5-wt % to 40-wt %. Dispersions were prepared by high-shear mixing techniques such as rotor-stator methods, ultrasonic methods, and other methods known to those skilled in the art.

Specifically, the dispersability of substantially spherical nanocrystalline metal oxides into alcohols was evaluated. More specifically, the evaluated alcohol was ethanol (EtOH). The substantially spherical nanocrystalline metal oxides tested were selected from a group comprising aluminum oxide, antimony tin oxide (ATO), cerium oxide, and zinc oxide. The most effective dispersant type for the substantially spherical nanocrystalline metal oxides was polyvinylpyrolidone with a MW of 9700—this is a polymeric material containing multiple basic anchor groups.

Specifically, the dispersability of substantially spherical nanocrystalline metal oxides into non-polar hydrocarbons was evaluated. More specifically, the evaluated non-polar hydrocarbon was heptane. The substantially spherical nanocrystalline metal oxides tested were selected from a group comprising aluminum oxide, antimony tin oxide (ATO), cerium oxide, iron oxide, indium tin oxide (ITO), and zinc oxide. The most effective dispersants feature two specific properties: (1) molecular weight greater than 1,000 and (2) one or more anchor groups exhibiting either acidic or basic character. Substantially spherical nanocrystalline metal oxides have both acid and base sites on their surface, and the effectiveness of these dispersants results from a strong affinity of the acid/basic anchor group for the surface sites. In addition, the polymeric chains associated with the dispersants are particularly effective at providing the steric repulsion necessary to prevent aggregation in the non-polar hydrocarbon.

Specifically, the dispersability of substantially spherical nanocrystalline metal oxides into polar hydrocarbons was evaluated. More specifically, the evaluated polar hydrocarbons were selected from the group consisting of propylmethoxyacetate (PMA), methyl ethyl ketone (MEK), and iso-propyl alcohol (IPA). The substantially spherical nanocrystalline metal oxides tested were selected from a group comprising aluminum oxide, antimony tin oxide (ATO), cerium oxide, and zinc oxide. For a given metal oxide, the better dispersant for a given polar hydrocarbon varied due to dispersant solubility in the tested polar hydrocarbon. But in general, the most effective dispersants feature two specific properties: (1) molecular weight greater than 1,000 and (2) multiple basic anchoring groups.

In general, a stable dispersion of substantially spherical nanocrystalline metal oxides and non-aqueous media is formed using (1) polymeric dispersants having molecular weight greater than 1000, and (1) one or more acidic or basic anchoring groups that interact with the metal oxide surface. In general, both homopolymers and copolymers can be effective dispersants for nanocrystalline metal oxides provided the following requirements are met: (1) molecular weight greater than 1000, (2) one or more achor groups with acidic or basic character, and (3) soluble in the non-aqueous media. However, certain homopolymer and copolymer dispersants may be rendered ineffective, even if the above listed requirements are met, due to:

Anchor groups are sterically hindered or inaccessible with respect to the metal oxide surface and are not able to efficiently interact to provide efficient particle dispersion in the non-aqueous media, and/or;

The acidic or basic character of the anchor group is of a chemical type that does not form an interaction with the metal oxide surface of sufficient strength to provide efficient particle dispersion in the non-aqueous media.

Theory not withstanding, there may exist a complex relationship between dispersant molecular weight and dispersion stability, making it is very difficult to generalize as to this relationship.

### EXAMPLE 1

### Zinc Oxide Dispersions in EtOH Using a Polymeric Dispersant

A dispersion of substantially spherical nanocrystalline zinc oxide in ethanol was prepared by combining 4.00 g of zinc oxide powder with a solution comprised of 0.20 g of polyvinylpyrolidone (PVP) K-15 (ISP Corporation) dissolved in 6.00 g of ethanol. The mixture was subjected to ultrasonic vibration for 30 minutes to yield a stable dispersion of the zinc oxide in ethanol.

The solvated particle size of ZnO nanoparticles was determined by DLS. For substantially spherical nanocrystalline zinc oxide—EtOH dispersion, made with PVP K-15, a mean volume-weighted solvated diameter of 320 nm was measured indicating no particle aggregation or flocculation.

TABLE 1
Substantially Spherical Nanocrystalline Zinc Oxide in EtOH

| Dispersant | Type | Viscosity | SPS, nm | Stability |
|---|---|---|---|---|
| Polyvinylpyrolidone | MW = 9700, | Low | 320 | Stable |
| | basic anchor | | | |
| Polyvinylpyrolidone | MW = 66,800, | Low | 340 | Stable |
| | basic anchor | | | |

### Comparative Example 1

### Zinc Oxide Dispersions in Ethanol Using Low Molecular Weight Dispersants

Dispersions of zinc oxide in ethanol were prepared by mixing 3.00 g of zinc oxide with 7.00 g of ethanol containing 0.30 g of the dispersants (surfactants, wetting agents, coupling agents, etc) listed in the table below. In one case, no dispersant was used. The resulting mixtures were subjected to ultrasonic vibration for 30 minutes. Compared to the polymeric dispersants listed in Example 1, none of the low molecular weight dispersants in Table 2 resulted in a stable dispersion of the nanocrystalline zinc oxide particles as evidenced by either rapid particle settling, flocculation, or gelling of the mixture.

TABLE 2
Substantially Spherical Nanocrystalline Zinc Oxide in EtOH

| | | | SPS, | |
|---|---|---|---|---|
| Dispersant | Type | Viscosity | nm | Stability |
| E 335 | 70% PVP, 30% | Very High | NA | Rapid |
| | polyvinylacetate | | | settling |
| Solsperse | Polymeric alkoxylate | Very High | NA | Flocculation |
| 20000 | | | | |
| Hydropalat | Nonionic and ionic | Very High | NA | Flocculation |
| 3216 | surfactant mixture | | | |
| KR-55 | Titanate coupling agent | Very High | NA | Flocculation |
| LICA 38 | Titanate coupling agent | Very High | NA | Rapid |
| | | | | settling |

### EXAMPLE 2

### Cerium Oxide Dispersions in Heptane Using a Polymeric Dispersant

Dispersions of nanocrystalline cerium oxide in heptane were prepared by blending 3.33 g of cerium oxide powder with 5.35 g of heptane and 40 wt % of the polymeric dispersants included in Table 3 with respect to cerium oxide (with the exception of 13 wt % for Solsperse 17000). The mixtures were subjected to ultrasonic vibration for 30 minutes, and each resulted in stable dispersions of the cerium oxide nanoparticles in heptane. The resulting mean particle diameter measured for each of the cerium oxide dispersions with the polymeric dispersants is also included in Table 3, with the results indicating a high degree of dispersion and no particle aggregation or flocculation.

TABLE 3
Substantially Spherical Nanocrystalline Cerium Oxide
Dispersions in Heptane

| | | | SPS, | |
|---|---|---|---|---|
| Dispersant | Type | Viscosity | nm | Stability |
| Solsperse 17000 | Basic polyamide/ | Low | 280 | Stable |
| | polyester | | | |
| Ganex V-216 | Polyvinylpyrolidone/ | Low | 320 | Stable |
| | poly-C16-olefin | | | |
| Ganex V-220 | Polyvinylpyrolidone/ | Low | 340 | Stable |
| | poly-C16-olefin | | | |
| Solsperse 3000 | Acidic polymer | Low | 340 | Stable |

### Comparative Example 2

### Cerium Oxide Dispersions in Heptane Using Low Molecular Weight Dispersants

Mixtures of nanocrystalline cerium oxide in heptane were prepared by blending 3.33 g of cerium oxide powder with 5.35 g of heptane and the polymeric dispersants in Table 4 at 40-wt % with respect to cerium oxide. The mixtures were subjected to ultrasonic vibration for 30 minutes. Compared to the stable dispersions achieved with polymeric dispersants in Example 2, none of the low molecular weight dispersants in Table 4 produced stable dispersions of cerium oxide in heptane.

TABLE 4
Substantially Spherical Nanocrystalline Cerium Oxide
Dispersions in Heptane

| | | | SPS, | |
|---|---|---|---|---|
| Dispersant | Type | Viscosity | nm | Stability |
| None | | Very High | NA | Flocculation |
| Stearic Acid | Fatty acid | High | 392 | Rapid |
| | | | | Settling |
| Lorama D100 | Fatty acid ester | High | 883 | Rapid |
| | | | | Settling |
| K-Sperse 131 | Alkylnaphthanlene- | Very High | NA | Flocculation |
| | sulfonicacid salt | | | |
| Emphos PS-21A | Phosphate ester | High | 608 | Rapid |
| | | | | Settling |
| Silwet L77 | Silicone polymer | Very High | NA | Flocculation |
| Stearamide | Fatty amide | Very High | NA | Flocculation |

### EXAMPLE 3

### Aluminum Oxide Dispersions in PMA Using Polymeric Dispersants

Dispersions of nanocrystalline aluminum oxide in propylmethoxyacetate (PMA) were prepared by blending 4.00 g of aluminum oxide powder with 5.60 g of PMA containing 0.40 g of the polymeric dispersants listed in Table 5. The mixtures were subjected to ultrasonic vibration for 30 minutes, to yield stable dispersions of the aluminum oxide nanoparticles in PMA. The resulting mean particle diameter measured for the two aluminum oxide dispersions with the polymeric dispersants is also included in Table 5 demonstrating the high degree of dispersion and stability.

TABLE 5
Substantially Spherical Nanocrystalline Aluminum Oxide
Dispersions in PMA

| | | | SPS, | |
|---|---|---|---|---|
| Dispersant | Type | Viscosity | nm | Stability |
| Solsperse 24000 | Basic polymer | Low | 120 | Stable |
| Solsperse 32000 | Basic polyamide/ | Low | 130 | Stable |
| | polyester | | | |
| Paraloid B-99N | Polymethylmethacrylate | Low | 140 | Stable |
| Disperbyk 111 | Acidic copolymer | Low | 130 | Stable |
| Disperbyk 163 | Block copolymer | Low | 130 | Stable |

### Comparative Example 3

### Aluminum Oxide Dispersions in PMA Using Low Molecular Weight Dispersants

Dispersions of nanocrystalline aluminum oxide in propylmethoxyacetate (PMA) were prepared by blending 2.00 g of aluminum oxide powder with 7.600 g of PMA containing 0.40 g of each of the low molecular weight dispersants listed in Table 6. The mixtures were subjected to ultrasonic vibration for 30 minutes. Compared to the aluminum oxide dispersions of Specific Example 3 prepared with polymeric dispersants, the low molecular weight dispersants in Table 6 did not produce stable dispersions of aluminum oxide in PMA.

TABLE 6
Aluminum Oxide Dispersions in PMA

| | | | SPS, | |
|---|---|---|---|---|
| Dispersant | Type | Viscosity | nm | Stability |
| Lorama D100 | Fatty acid ester | Very High | NA | Rapid |
| | | | | Settling |
| K-Sperse 131 | Alkylnaphthanlene- | Very High | NA | Flocculation |
| | sulfonicacid salt | | | |
| Emphos PS-21A | Phosphate ester | Very High | NA | Rapid |
| | | | | Settling |
| Ser-Ad FA 196 | Anionic Surfactant | Very High | NA | Rapid |
| | | | | Settling |

The preceding embodiments are illustrative of the practice of the invention. It is to be understood, however, that other expedients known to those skilled in the art, or disclosed herein, may be employed without departing from the spirit of the invention or the scope of the appended claims. Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A process to prepare a stable dispersion of nanoparticles and non-aqueous media, the process comprising:
combining a polymeric dispersant with the non-aqueous media to form a mixture; and
adding nanoparticles to the mixture.

2. The process of claim 1, further comprising:
selecting one of metal oxides and mixed metal oxides as the nanoparticles to add to the mixture.

3. The process of claim 2, further comprising selecting metal oxides from a group comprising aluminum oxide, zinc oxide, iron oxide, cerium oxide, chromium oxide, antimony tin oxide, and indium tin oxide as the nanoparticles to add to the mixture.

4. The process of claim 1, further comprising:
selecting one of substantially spherical nanocrystalline metal oxides and substantially spherical nanocrystalline mixed metal oxides as the nanoparticles to add to the mixture.

5. The process of claim 1, further comprising:
selecting the nanoparticles generally to have a size distribution and range in mean diameter from about 1 nm to about 900 nm.

6. The process of claim 5, wherein the selecting step comprises:
selecting the nanoparticles generally to have a size distribution and range in mean diameter from about 2 nm to about 100 nm.

7. The process of claim 6, wherein the selecting step comprises:
selecting the nanoparticles generally to have a size distribution and range in mean diameter from about 5 nm to about 40 nm.

8. The process of claim 1, further comprising:
selecting the polymeric dispersant to have a molecular weight greater than 1000 and to have one or more functional groups capable of anchoring to a surface of at least one of the nanoparticles.

9. The process of claim 8, wherein the polymeric dispersant anchors to the surface through at least one of acidic interactions, basic interactions, neutral interactions, and covalent interactions

10. The process of claim 9, wherein interaction between the polymeric dispersant and the at least one of the nanoparticles is of one of cationic character, anionic character, and neutral character.

11. The process of claim 1, wherein the polymeric dispersant is soluble in the non-aqueous media.

12. The process of claim 1, further comprising:
selecting the non-aqueous media from a group comprising polar hydrocarbons, non-polar hydrocarbons, alcohols, and silicons.

13. The process of claim 1, wherein the step of combining comprises:
mixing the polymeric dispersant to the non-aqueous media.

14. The process of claim 13, wherein the step of mixing is accomplished through one of high-shear mixing and ultrasonic mixing of the polymeric dispersant to the non-aqueous media.

15. The process of claim 1, wherein the step of adding comprises:
mixing the nanoparticles with the mixture.

16. The process of claim 15, wherein the step of adding is accomplished through one of high-shear mixing and ultra-sonic mixing the nanoparticles with the mixture.
